(19) United States
(12) Patent Application Publication
(10) Pub. No.: US 2020/0260770 A1
(43) Pub. Date: Aug. 20, 2020

(54) BLENDS OF OKARA WITH CELLULOSE DERIVATIVES

(71) Applicant: Dow Global Technologies LLC, Midland, MI (US)

(72) Inventors: Yongfu Li, Midland, MI (US); Tirtha Chatterjee, Midland, MI (US); Puspendu Deo, Pearland, TX (US); Mark W. Beach, Midland, MI (US); Matthew Larive, Bay City, MI (US); Dev Barpanda, Midland, MI (US)

(21) Appl. No.: 15/776,158

(22) PCT Filed: Dec. 13, 2016
(86) PCT No.: PCT/US2016/066255

§ 371 Date: May 15, 2018

Related U.S. Application Data
(60) Provisional application No. 62/269,140, filed on Dec. 18, 2015.

(51) Int. Cl. A23L 33/24; A23L 33/185

(52) U.S. Cl. CPC A23L 33/24; A23L 33/185

(57) ABSTRACT

Provided is a composition comprising
(a) 0.5% to 15% okara or whole soy or a mixture thereof, by weight based on the weight of the composition, and
(b) 0.1% to 1.4% one or more cellulose derivative selected from one or more methylcelluloses, one or more hydroxypropylmethylcelluloses, and mixtures thereof.

In certain formulations, it is desirable to create a mechanically robust structure. It is also often desirable that some or all of the ingredients in such a formulation be nutritionally beneficial. For example, vegetable patties are made from ingredients that include plant protein, vegetable oil, thickeners, and flavorings. A desirable characteristic of vegetable patties is that they retain their shape well, especially after being cooked.

US 20100112187 describes a meat analog patty containing soy protein, okara, and 1.5 weight % METHOCEL™ A4M. It is desired to provide a composition that can provide good structure to a formulation, for example to a vegetable patty. It is also desirable to provide a composition that has relatively low amount of cellulose derivative. One reason for desiring to reduce the amount of cellulose derivative is that cellulose derivative is usually more expensive than other typical ingredients. Another reason for desiring to reduce the amount of cellulose derivative is that some consumers find that when large amounts of cellulose derivative are used in some food products, the result can be an undesirable feeling in the mouth.

The following is a statement of the invention.

A first aspect of the present invention is a composition comprising
(a) 0.5% to 15% okara or whole soy or a mixture thereof, by weight based on the weight of the composition, and
(b) 0.1% to 1.4% one or more cellulose derivative selected from one or more methylcelluloses, one or more hydroxypropylmethylcelluloses, and mixtures thereof.

The following is a detailed description of the invention.

As used herein, the following terms have the designated definitions, unless the context clearly indicates otherwise.

Okara is produced during the processing of soybeans. Okara is often considered to be a by-product from the production of tofu and/or soy milk. In a typical process of processing soybeans, the soybeans are pureed, chopped, ground, or otherwise reduced in size; then the soybeans are mixed with water and heated to a temperature above 25° C.; then the resulting mixture is filtered to form a liquid portion and a solid portion. In this typical processing scheme, the liquid portion is soy milk and the solid portion is okara. Dry okara contains 30% to 70% by weight dietary fiber, 10% to 40% by weight protein, 5% to 20% by weight lipids, and 5% to 30% by weight other compounds.

Whole soy is a product made by grinding soy beans. Whole soy is normally supplied in the form of a powder.

Cellulose is a naturally occurring organic polymer consisting of linear chain of linked D-glucose units. Cellulose is often reacted with one or more of various reagents to produce various derivatives. Two such derivatives are methylcellulose polymer and hydroxypropyl methylcellulose polymer.

Methylcellulose polymer (MC) is a compound that has repeat units of the structure I:

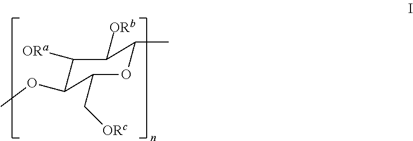

In structure I, the repeat unit is shown within the brackets. The index n is sufficiently large that structure I is a polymer; that is, n is sufficiently large that the “2% solution viscosity” (as defined below) of the compound is 2 mPa*s or higher. In MC, —R^{a}, —R^{b}, and —R^{c} is each independently chosen from —H and —CH₃. The choice of —R^{a}, —R^{b}, and —R^{c} may be the same in each repeat unit, or different repeat units may have different choices of —R^{a}, —R^{b}, and —R^{c}.

Methylcellulose polymer is characterized by the weight percent of methoxyl groups. The weight percentages are based on the total weight of the methylcellulose polymer. By convention, the weight percent is an average weight percentage based on the total weight of the cellulose repeat unit, including all substituents. The content of the methoxyl group is reported based on the mass of the methoxyl group (i.e., —OCH₃). The determination of the % methoxyl in methylcellulose (MC) polymer is carried out according to the United States Pharmacopeia (USP 37, “Methylcellulose”, pages 3776-3778).

Methylcellulose polymer is also characterized by the viscosity of a 2 wt.-% solution in water at 20° C. The 2% by weight methylcellulose polymer solution in water is prepared and tested according to United States Pharmacopeia (USP 37, “Methylcellulose”, pages 3776-3778). As described in the United States Pharmacopeia, viscosities of less than 600 mPa·s are determined by Ubbelohde viscosity measurement and viscosities of 600 mPa·s or more are determined using a Brookfield viscometer. When the 2 wt-% solution of MC has been made, the correct viscometer chosen, and the viscosity measured, the resulting measured viscosity is known herein as the “2% solution viscosity.”

Methylcellulose polymer is also characterized by the degree of the methyl substitution, DS(methyl), also designated as DS(methoxyl), which is the average number of OH groups that had been present on the original cellulose molecule that have been substituted with methyl groups, per anhydroglucose unit.

Another useful characterization of methylcellulose polymer is the quotient s23/s26. The numerals 2, 3, and 6 refer to the carbon atoms on the anyhdroglucose units, defined as in structure IA:

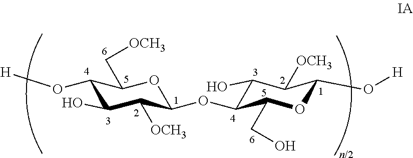

The parameter s23 is the molar fraction of anhydroglucose units wherein only the two hydroxy groups in the 2- and 3-positions of the anhydroglucose unit are substituted with methyl groups, and the parameter s26 is the molar fraction of anhydroglucose units wherein only the two hydroxy groups in the 2- and 6-positions of the anhydroglucose unit are substituted with methyl groups. For determining the s23, the term “the molar fraction of anhydroglucose units wherein only the two hydroxy groups in the 2- and 3-positions of the anhydroglucose unit are substituted with methyl groups” means that the two hydroxy groups in the 2- and 3-positions are substituted with methyl groups and the 6-positions are unsubstituted hydroxy groups. For determining the s26, the term “the molar fraction of anhydroglucose units wherein only the two hydroxy groups in the 2- and 6-positions of the anhydroglucose unit are substituted with methyl groups” means that the two hydroxy groups in the 2- and 6-positions are substituted with methyl groups and the 3-positions are unsubstituted hydroxy groups. The quotient s23/s26 is determined by dividing s23 by s26.

Hydroxypropyl methylcellulose polymer (HPMC) has the structure I, where —R^{a}, —R^{b}, and —R^{c} is each independently chosen from —H, —CH₃, and structure II:

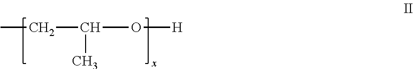

The choice of —R^{a}, —R^{b}, and —R^{c} may be the same in each repeat unit, or different repeat units may have different choices of —R^{a}, —R^{b}, and —R^{c}. The number x is an integer of value 1 or larger. One or more of —R^{a}, —R^{b}, and —R^{c} has structure II on one or more of the repeat units.

Hydroxypropyl methylcellulose polymer (HPMC) is characterized by the weight percent of methoxyl groups. The weight percentages are based on the total weight of the hydroxypropyl methylcellulose polymer. By convention, the weight percent is an average weight percentage based on the total weight of the cellulose repeat unit, including all substituents. The content of the methoxyl group is reported based on the mass of the methoxyl group (i.e., —OCH₃). The determination of the % methoxyl in hydroxypropyl methylcellulose polymer is carried out according to the United States Pharmacopeia (USP 37, “Hypromellose”, pages 3296-3298).

Hydroxypropyl methylcellulose polymer is characterized by the weight percent of hydroxypropyl groups. The weight percentages are based on the total weight of the hydroxypropyl methylcellulose polymer. The content of the hydroxypropoxyl group is reported based on the mass of the hydroxypropoxyl group (i.e., —O—C₃H₆OH). The determination of the % hydroxypropoxyl in hydroxypropyl methylcellulose (HPMC) is carried out according to the United States Pharmacopeia (USP 37, “Hypromellose”, pages 3296-3298).

Hydroxypropylmethylcellulose polymer is also characterized by the viscosity of a 2 wt. % solution in water at 20° C. The 2% by weight hydroxypropylmethylcellulose polymer solution in water is prepared and tested according to United States Pharmacopeia (USP 37, “Hypromellose”, pages 3296-3298). As described in the United States Pharmacopeia, viscosities of less than 600 mPa·s are determined by Ubbelohde viscosity measurement and viscosities of 600 mPa·s or more are determined using a Brookfield viscometer. When the 2 wt-% solution of HPMC has been made, the correct viscometer chosen, and the viscosity measured, the resulting measured viscosity is known herein as the “2% solution viscosity.”

A cellulose derivative selected from one or more MC, one or more HPMC, or a mixture thereof, is referred to herein as ingredient (b).

After a solution is made of ingredient (b) dissolved in water, the solution may show a gelation temperature. That is, for many ingredient (b) compounds, after the solution is made and brought to 25° C., if the temperature is then raised, the solution will form a gel. It is noted that some compounds that are suitable for use in ingredient (b) need to be cooled to a temperature below 25° C. in order to dissolve those compounds in water.

Formation of gel is assessed as follows. Aqueous ingredient (b) solutions were subjected to small-amplitude oscillatory shear flow (frequency=1 rad/sec, and strain amplitude low enough to maintain linear viscoelastic response) while warming from 10 to 90° C. at 1° C./min in a rotational rheometer. The shear storage modulus G and the shear loss modulus G′ are obtained from the oscillation measurements as a function of temperature. The magnitude component of complex shear modulus is

|G*|=\sqrt{G′²+G″²}.

At the lowest temperature, G′ is less than G″, characteristic of a liquid-like system. As the temperature is raised, typically G′ slowly decreases, reaches a minimum, and then rises rapidly as the system gels. As the temperature continues to rise, G″ becomes equal to G″, and then at higher temperatures, G′ is greater than G″, characteristic of a solid-like system. The crossover temperature at which G′=G″ is referred to herein as the gelation temperature (Tgel). The parameter Tgel is considered herein to be a characteristic of a given cellulose derivative when Tgel is measured at frequency of 1 rad/sec on a solution of 1% by weight of that cellulose derivative in water.

Proteins are molecules that contain chains of amino acid residues. Proteins contain 30 or more residues of amino acids. Proteins that have been removed from a plant are known as plant proteins.

As used herein, the term “sugar” refers to monosaccharides and disaccharides.

Vegetable oils are compounds that have been removed from plants. Vegetable oils are triglycerides, which have the structure of tri-esters of carboxylic acids with glycerol. In vegetable oils, each residue of the carboxylic acids has 12 or more carbon atoms.

The composition of the present invention contains 0.5% to 15% okara or whole soy or a mixture thereof, by weight based on the weight of the composition. Preferred is okara. Preferably the amount of okara is, by weight based on the weight of the composition, 1% or more; more preferably 2% or more. Preferably the amount of okara is, by weight based on the weight of the composition, 12% or less; more preferably 9% or less; more preferably 6% or less.

The composition of the present invention contains one or more ingredient (b) selected from one or more MC, one or more HPMC, or a mixture thereof. Preferably, ingredient (b) contains one or more MC.

Preferably, ingredient (b) has % methoxyl of 18% or more; more preferably 25% or more. Preferably, ingredient (b) has % methoxyl of 50% or less; more preferably 40% or less; more preferably 35% or less.

Preferably, ingredient (b) has 2% solution viscosity of 1,000 mPa·s or more; more preferably 2,500 mPa·s or more; more preferably 5,000 mPa·s or more. Preferably, ingredient (b) has 2% solution viscosity of 70,000 mPa·s or less; more preferably 50,000 mPa·s or less.

Preferably, ingredient (b) has gel temperature of 30° C. or higher; more preferably 33° C. or higher; more preferably 36° C. or higher. Preferably, ingredient (b) has gel temperature of 95° C. or lower; more preferably 75° C. or lower; more preferably 49° C. or lower; more preferably 47° C. or lower.

Among methylcellulose polymers, the quotient 23/s26 is preferably 0.36 or less, preferably 0.33 or less, more preferably 0.30 or less, most preferably 0.27 or less, or 0.26 or less, and particularly 0.24 or less or 0.22 or less. Preferably the quotient s23/s26 is 0.08 or more, 0.10 or more, 0.12 or more, 0.14 or more, or 0.16 or more.

Among methylcellulose polymers, DS(methyl) is preferably 1.55 or higher; more preferably 1.65 or higher; more preferably 1.70 or higher. Among methylcellulose polymers, DS(methyl) is preferably 2.25 or lower; more preferably 2.20 or lower; more preferably 2.10 or lower.

The amount of ingredient (b) is 0.1% to 1.4% by weight based on the weight of the composition. Preferably, the amount of ingredient (b) is, by weight based on the weight of the composition, 0.2% or more; more preferably 0.4% or more. Preferably, the amount of ingredient (b) is, by weight based on the weight of the composition, 1.3% or less; more preferably 1.2% or less; more preferably 1.1% or less.

Preferably, the composition of the present invention contains water. Preferably, the amount of water, by weight based on the composition, is 20% or more; more preferably 30% or more; more preferably 40% or more; more preferably 50% or more. Preferably, the amount of water, by weight based on the composition, is 80% or less; more preferably 70% or less.

Preferably, the composition of the present invention contains 20% to 80% by weight, based on the weight of the composition, ingredients selected from one or more proteins, sodium chloride, one or more sugars, and mixtures thereof.

Preferably, the composition of the present invention contains one or more protein in addition to the okara, whole soy, or mixture thereof. Preferred proteins are plant proteins; more preferred are proteins from soy, proteins from wheat, and mixtures thereof. Preferably the amount of proteins, by weight based on the weight of the composition, is 5% or more; more preferably 10% or more; more preferably 15% or more. Preferably the amount of proteins, by weight based on the weight of the composition, is 30% or less; more preferably 25% or less.

Preferably, the amount of soy proteins in the composition of the present invention is, by weight based on the weight of the composition, 5% or more; more preferably 10% or more; more preferably 15% or more. Preferably the amount of proteins, by weight based on the weight of the composition, is 30% or less; more preferably 25% or less.

Preferably, the composition of the present invention contains one or more sugar. Preferred sugars are sucrose, fructose, glucose (also known as dextrose), and mixtures thereof. Preferably the amount of sugar is, by weight based on the weight of the composition, 0.1% or more; more preferably 0.2% or more; more preferably 0.3% or more. Preferably the amount of sugar is, by weight based on the weight of the composition, 5% or less; more preferably 3% or less; more preferably 1% or less.

Preferably, the composition of the present invention contains sodium chloride. Preferably, the amount of sodium chloride is, by weight based on the weight of the composition, 0.05% or more; more preferably 0.1% or more; more preferably 0.2% or more. Preferably, the amount of sodium chloride is, by weight based on the weight of the composition, 5% or less; more preferably 2% or less; more preferably 1% or less; more preferably 0.5% or less.

Preferably, the composition of the present invention contains one or more vegetable oils. Preferably, the amount of vegetable oils is, by weight based on the weight of the composition, 5% or more; more preferably 10% or more; more preferably 20% or more. Preferably, the amount of vegetable oils is, by weight based on the weight of the composition, 50% or less; more preferably 40% or less; more preferably 30% or less.

Preferably, the composition of the present invention either contains no meat or else, if meat is present, contains an amount of meat that is 0.1% or less by weight, based on the weight of the composition.

A preferred use for the composition of the present invention is the formation of patties. A patty is a solid object that weighs from 50 grams to 500 grams. Preferred patties have smallest dimension of 3 cm or less; more preferably 2 cm or less. Preferred patties have circular, hexagonal, or square symmetry around the axis defined by the smallest dimension; more preferred is circular symmetery.

Preferably, patties are formed by a process that takes place at temperatures between 15° C. and 30° C. Preferably, the process of forming the patties includes bringing the ingredients of the composition of the present invention into contact with each other, then mechanically mixing to blend the ingredients. Preferably, portions of the resulting mixture are formed into patties.

Preferably, patties, after formation and prior to cooking, hold their shape when placed on a flat surface at 25° C. for 10 minutes.

Preferably, patties are cooked after formation. Cooking may be performed by any method that exposes the patties to elevated temperature sufficient to raise the internal temperature of the patty to 60° C. or higher. Preferably, patties again hold their shape when placed on a flat surface at 25° C. for 10 minutes, after the completion of the cooking process.

It is contemplated that the composition of the present invention is useful for improving the rheology of formulations, including the flow characteristics of liquid formulations and/or the hardness of solid formulations. Additionally, it is contemplated that the composition of the present invention is useful for improving the rheology of edible formulations.

The following are examples of the present invention.

Ingredients were as follows:
Soy1=Response™ 4401 soy protein from Dupont Corporation.
Soy2=Response™ 4320 soy protein from Dupont Corporation.
Glu=FP™ 600 modified wheat gluten from MPG Ingredients.
Oil=vegetable oil
Flay=beef flavoring
MCG=Methocel™ SGA16M, methylcellulose from Dow Chemical Company:
   2% viscosity: 16,000 MPa·s
   % methoxyl: 27.5% to 31.5%
MCA=Methocel™ A4M, methylcellulose from Dow Chemical Company
   2% viscosity: 2,600 to 5,000 MPa·s
   % methoxyl: 27.5% to 31.5%
HPMC=Methocel™ K4M, hydroxypropylmethylcellulose from Dow Chemical Company
   2% viscosity: 2,600 to 5,000 MPa·s
   % methoxyl: 19% to 24%
   % hydroxypropyl: 7% to 12%
Sugar=Clintose™ dextrose from ADM Corporation

### EXAMPLE 1

### Rheology

Solutions and dispersions were made as follows.

Solutions containing METHOCEL™ only were prepared as follows. Before use, the METHOCEL™ powders were dried overnight in an oven (under vacuum) at 80° C. Pre-weighed amount of water (based on sample composition) was introduced into a clean glass vial. The vial was warmed on a hot plate with stirring (propeller type magnetic stirrer) until the water temperature reached about 85° C. Pre-weighed amount (based on sample composition, typically 1% w/w) of METHOCEL™ powder was then introduced with stirring into the hot water solution. The METHOCEL™ powder/hot water slurry was stirred for another twenty minutes (with heating turned off). Subsequently the vial was capped and transferred to a flat bed shaker (at room temperature, approximately 23° C.) for 2 hrs. Finally, the vial was stored in a refrigerator overnight set at 4° C. (or 24 hrs.) before any rheological measurements. The total sample weight was approximately 60 g.

Solution/dispersions containing okara only were made as follows.

Okara powders were used as received without any drying before sample preparation. Pre-weighed amount of water (based on sample composition, 2.5% or 5%, w/w) was introduced into a clean glass vial. The vial was warmed on a hot plate with stirring (propeller type magnetic stirrer) until the water temperature reached about 85° C. Pre-weighed amount (based on sample composition) of Okara powder was then introduced with stirring into the hot water solution. The Okara powder/hot water slurry was stirred for another twenty minutes (with heating turned off). Subsequently the vial was capped and transferred to a flat bed shaker (at room temperature, approximately 23° C.) for 2 hrs. Finally, the vial was stored in a refrigerator set at 4° C. overnight (or 24 hrs.) before any rheological measurements. The total sample weight was approximately 60 g.

Solution/dispersions containing both okara and Methocel™ were made as follows. Before use, the METHOCEL™ powders were dried overnight in an oven (under vacuum) at 80° C. Okara powders were used as received without any drying before sample preparation. METHOCEL™ and Okara powders were weighed as per sample composition and mixed using a spatula. Water was introduced into a clean glass vial. The vial was warmed on a hot plate with stirring (propeller type magnetic stirrer) until the water temperature reached about 85° C. Pre-weighed powder mixture was then introduced with stirring into the hot water solution. The powder/hot water slurry was stirred for another twenty minutes (with heating turned off). Subsequently the vial was capped and transferred to a flat bed shaker (at room temperature, approximately 23° C.) for 2 hrs. Finally, the vial was stored in a refrigerator set at 4° C. overnight (or 24 hrs.) before any rheological measurements.

Rheology measurements of the solution/dispersions were made as follows. Rheology was measured in a strain controlled ARES™ RFSIII rheometer (TA Instruments) with Couette (cup and bob) fixture. The key Couette fixture dimensions were: 34 mm i.d. for the cup, and 32 mm o.d. and 33.33 mm height for the bob dimensions. The bob had a convex cone bottom and was fabricated in-house. Strain-amplitude sweeps were performed to determine the linear viscoelastic (LVE) regime, where evolved stress is proportional of applied strain amplitude. Dynamic frequency sweep was performed under small-amplitude oscillatory shear at 20° C. with frequency range 400-0.01 rad/s, and strain amplitude in LVE regime. In this case, the shear storage modulus (G′) and loss modulus (G″) were monitored as a function of frequency (ω). Further, (complex) viscosity (|η*|) can be calculated using the relation:

$$\vert {η}^{*} \vert = \frac{\sqrt{{G}^{′2} + {G}^{″2}}}{ω}$$

The magnitude of the complex viscosity (|η*|) at a fixed representative frequency (1.0 rad/s) are reported and compared. Steady shear rate sweep was performed for strain rate range 0.03-500/s. In this case steady shear viscosity (η) is monitored as a function of shear strain rate. Steady shear viscosity (η) at a fixed representative strain rate (0.3/s) are reported and compared.

For all samples, gel temperatures were measured using temperature sweep (10 to 90 to 10° C. with 1° C./min warming/cooling rate) under small-amplitude oscillatory shear flow condition (strain amplitude in LVE regime and 1.0 rad/s frequency) using the same rheometer and couette fixture described above. About 2-3 mL of a low density water-immiscible polydimethylsiloxane oil (5 cSt viscosity, density of 0.918 g/mL, molecular weight of 770 g/mol) was layered/floated over the aqueous solution by disposable pipette after the solution level rose above the bob top to minimize solvent evaporation at elevated temperature. The storage (G′) and loss (G″) moduli were monitored as a function of temperature. The crossover temperature at which G′=G″ in the warming cycle is considered as a metric representing Tgel. Other reported metrics are shear storage modulus (G′) and magnitude component of complex shear modulus, |G*| at 25° C.

Results on the comparative examples were as follows. “Ex.” means Example, and examples with a number ending in “C” are comparative examples. “n.d.” means none detected.

TABLE 1A
rheology results on comparative examples. Percentages
are by weight, based on the total weight of the example

| | | | | | \|η*\| | η | | | |
|---|---|---|---|---|---|---|---|---|---|
| | MCA | HPMC | MCG | Okara | (Pa · | (Pa · | G′ | \|G*\| | Tgel |
| Ex | (%) | (%) | (%) | (%) | s) | s) | (Pa) | (Pa) | (° C.) |
| 1C | 1 | | | | 0.35 | 0.41 | 0.011 | 0.243 | 54.4 |
| 2C | | 1 | | | 0.34 | 0.36 | 0.013 | 0.244 | 71.3 |
| 3C | | | 1 | | 1.15 | 1.58 | 0.188 | 0.821 | 46.4 |
| 4C | | | | 2.5 | 0.94 | 0.26 | 0.770 | 0.821 | n.d.⁽¹⁾ |
| 5C | | | | 5 | 5.44 | 1.12 | 6.355 | 6.415 | n.d.⁽¹⁾ |

Note:
⁽¹⁾G′ > G″ at all measured temperatures. At 23° C., if the container is inverted, the composition will flow under the influence of gravity. This liquid-like behavior is reflected in the relatively low values of |G*| and G′.

TABLE 1B
rheology results on working examples. Percentages are
by weight, based on the total weight of the example

| | MCA | HPMC | MCG | Okara | \|η*\| | η | G′ | \|G*\| | Tgel |
|---|---|---|---|---|---|---|---|---|---|
| Ex | (%) | (%) | (%) | (%) | (Pa · s) | (Pa · s) | (Pa) | (Pa) | (° C.) |
| 6 | 1 | | | 2.5 | 1.55 | 2.85 | 0.454 | 1.470 | 53.3 |
| 7 | | 1 | | 2.5 | 1.24 | 2.13 | 0.711 | 1.930 | 72.4 |
| 8 | | | 1 | 2.5 | 5.96 | 9.61 | 3.621 | 7.043 | 35.4 |
| 9 | 1 | | | 5 | 89.90 | 71.49 | 129.6 | 157.1 | n.d.⁽²⁾ |
| 10 | | 1 | | 5 | 99.35 | 60.59 | 93.7 | 120.3 | n.d.⁽²⁾ |
| 11 | | | 1 | 5 | 122.34 | 123.74 | 111.4 | 125.9 | n.d.⁽²⁾ |

Note:
⁽²⁾G′ > G″ at all temperatures. At 23° C., if the container is inverted, the composition will not flow under the influence of gravity. This solid-like behavior is reflected in the relatively high values of |G*| and G′.

In the working examples that contain 2.5% okara, the results for the steady shear viscosity η show that the samples that have both okara and a cellulose derivative have much higher viscosity than would be predicted from adding together the separate contributions of okara and cellulose derivative. For example, examples 1C, 4C, and 6 may be examined The steady shear viscosity of example 6 is 2.85 Pa·s, far higher than would be expected from examination of examples 1C and 4C. The same effect is apparent from examination of the parameters G′ and |G*|: the values of G and |G*| in example 6 are far higher than would be expected from examination of examples 1C and 4C. Similarly, the values of G′, and G* for example 8 are all much higher than would be expected from examination of examples 3C and 4C.

These same effects are even more apparent in the working examples that contain 5% okara.

It is contemplated that the rheological results demonstrate that the mixture of cellulose derivative with okara provides a unique increase in viscosity, which could be useful in a variety of formulations. It is further contemplated that the increase in viscosity is created by a unique physical structure, which can strength to a solid article made from such a formulation.

### EXAMPLE 2

### Patties

The formulations used for making patties were as follows.

TABLE 2A
Patty Formulations. Amounts are percent by weight,
based on the weight of the formulation.

| Ex. | 21C | 22C | 23C | 24C | 25 | 26 | 27C | 28 | 29 |
|---|---|---|---|---|---|---|---|---|---|
| water | 63.51 | 63.51 | 63.51 | 63.51 | 63.51 | 63.51 | 63.51 | 63.51 | 63.51 |
| Soy1 | 21.32 | 19.10 | 17.48 | 20.48 | 18.23 | 16.86 | 20.9 | 18.67 | 17.17 |
| Gluten | 4.53 | 4.53 | 4.53 | 4.53 | 4.53 | 4.53 | 4.53 | 4.53 | 4.53 |
| Oil | 3.18 | 3.18 | 3.18 | 3.18 | 3.18 | 3.18 | 3.18 | 3.18 | 3.18 |
| Soy2 | 4.04 | 3.76 | 2.88 | 3.88 | 3.63 | 2.51 | 3.96 | 3.69 | 2.69 |
| Flavor | 2.72 | 2.72 | 2.72 | 2.72 | 2.72 | 2.72 | 2.72 | 2.72 | 2.72 |
| MCG | 0 | 0 | 0 | 1.0 | 1.0 | 1.0 | 0.5 | 0.5 | 0.5 |
| sugar | 0.45 | 0.45 | 0.45 | 0.45 | 0.45 | 0.45 | 0.45 | 0.45 | 0.45 |
| NaCl | 0.25 | 0.25 | 0.25 | 0.25 | 0.25 | 0.25 | 0.25 | 0.25 | 0.25 |
| okara | 0 | 2.5 | 5.0 | 0 | 2.50 | 5.0 | 0 | 2.5 | 5.0 |

| Ex. | 30C | 31 | 32C |
|---|---|---|---|
| water | 63.51 | 63.51 | 63.51 |
| Soy1 | 21.1 | 18.89 | 17.32 |
| Gluten | 4.53 | 4.53 | 4.53 |
| Oil | 3.18 | 3.18 | 3.18 |
| Soy2 | 4.02 | 3.72 | 2.79 |
| Flavor | 2.72 | 2.72 | 2.72 |
| MCG | 0.25 | 0.25 | 0.25 |
| sugar | 0.45 | 0.45 | 0.45 |
| NaCl | 0.25 | 0.25 | 0.25 |
| okara | 0 | 2.5 | 5.0 |

The ingredients were mixed as follows. Gluten, okara (if present) and MCG (if present) were mixed as dry powders in a mixer. Water at 5° C. was added, and the mixture was agitated with a whip attachment at medium speed until a uniform slurry was formed. Flavoring, sugar, and NaCl were added, and the agitation continued for 1 minute on high speed. Then Soy1 was added, and the formulation was mixed for 5 minutes, continually pushing the mixture down on the sides of the container. Then Soy2 was added, and the formulation was mixed for 5 minutes, continually pushing the mixture down on the sides of the container. Then oil was added, and the formulation was mixed for 5 minutes, continually pushing the mixture down on the sides of the container. The mixture was placed in a refrigerator at 5° C. for 2 hours.

To form each patty, 80 g of the mixture was placed into a cylidrical mold. Mold dimensions were 1 cm height and 9 cm diameter. Patties were then placed in a freezer at −15 to −20° C. until frozen, and then each patty was separately wrapped and re-placed into the freezer until testing.

Patties were removed from the freezer and cooked as follows. Frozen patties were placed in a lightly oiled (PAM™ cooking spray) 25.4 cm (10 inch) diameter frying pan on medium heat for 4 minutes on each side. One patty was heated at a time and immediately transferred to the texture analyzer to be tested at an internal patty temperature of 70° C. to 75° C.

After cooking, patties were observed (“Obs.”). Patties that held their shape were rated “OK,” and patties that were broken or crumbled were rated “poor.” If the patties held their shape, they were tested for hardness. The patty hardness was measured with a Texture Analyzer (model TA.XTPlus, from Texture Technologies, Corp, NY, USA) using a 2.5 cm diameter acrylic cylindrical probe. The patty was compressed at the approximate middle point with the probe for the patty hardness. As a result of these characterization techniques, a plot of the resulting force vs. time compression was obtained. The maximum force is taken as the patty hardness force in Newtons. Results were as follows. “nt” means not tested.

TABLE 2B
Results after Cooking

| Ex. | % MCG | % Okara | Obs. | Hardness (N) |
|---|---|---|---|---|
| 21C | 0 | 0 | poor | nt |
| 22C | 0 | 2.5 | poor | nt |
| 23C | 0 | 5 | poor⁽¹⁾ | 0 |
| 24C | 1 | 0 | OK | 19.5 |
| 25 | 1 | 2.5 | OK | 23.5 |
| 26 | 1 | 5 | OK | 31 |
| 27C | 0.5 | 0 | OK | 5⁽²⁾ |
| 28 | 0.5 | 2.5 | OK | 21 |
| 29 | 0.5 | 5 | OK | 25 |
| 30C | 0.25 | 0 | poor | nt |
| 31 | 0.25 | 2.5 | OK | 17 |
| 32 | 0.25 | 5 | OK | 19 |

⁽¹⁾the patty broke in half during the cooking process
⁽²⁾The appearance of the patty was OK, but the patty was unacceptable because the mechanical strength was not sufficient to provide the texture that consumers expect in a patty. This lack of mechanical strength is shown by the very low hardness value of 5 N.

The patties with no MCG (21C, 22C, and 23C) either did not hold their shape or else fell apart during cooking. The patties with MCG only either did not hold their shape (30C) or else had relatively low hardness (24C and 27C) in comparison to patties that had the same amount of MCG and that also contained okara. The hardness of comparative sample 27C was so low that the patty was unacceptable. The patties with both MCG and okara had good hardness.

1. A composition comprising
(a) 0.5% to 15% okara or whole soy or a mixture thereof, by weight based on the weight of the composition, and
(b) 0.1% to 1.4% one or more cellulose derivative selected from one or more methylcelluloses, one or more hydroxypropylmethylcelluloses, and mixtures thereof.

2. The composition of claim 1, wherein said composition comprises 0.5% to 15% okara.

3. The composition of claim 1, additionally comprising 20% to 80% water, by weight based on the weight of the composition.

4. The composition of claim 1, additionally comprising 20% to 80% one or more dry ingredients selected from the group consisting of one or more proteins, sodium chloride, one or more sugars, and mixtures thereof, by weight based on the weight of the composition.

5. The composition of claim 1, additionally comprising 5% to 40% one or more plant proteins, by weight based on the weight of the composition.

6. The composition of claim 1, wherein the cellulose derivative has viscosity of a 2% by weight solution in water at 20° C. of 5,000 mPa*s or higher.

7. The composition of claim 1, wherein the cellulose derivative has gel formation temperature of 45° C. or less.
